(19) United States
(12) Patent Application Publication
(10) Pub. No.: US 2015/0312202 A1
(43) Pub. Date: Oct. 29, 2015

(54) Method of Managing Social Media Distractions over a Social Networking Application by Executing Computer-Executable Instructions Stored On a Non-Transitory Computer-Readable Medium

(71) Applicant: Mark A. Gabbidon, Johnson City, NY (US)

(72) Inventor: Mark A. Gabbidon, Johnson City, NY (US)

(21) Appl. No.: 14/662,225

(22) Filed: Mar. 18, 2015

Related U.S. Application Data
(60) Provisional application No. 61/981,781, filed on Apr. 19, 2014.
(60) Provisional application No. 61/955,125, filed on Mar. 18, 2014.

(51) Int. Cl. H04L 12/58; G06F 3/16; H04L 29/06

(52) U.S. Cl. CPC H04L 51/32; H04L 65/403; H04L 65/60; G06F 3/162

(57) ABSTRACT

A method of managing social media distractions over a social networking application allows status descriptions to be automatically generated and displayed on a networking application based on automatic detection of media being engaged with on a device. Additionally, users are aided in managing distractions such as video chatting on social media while consuming media or experiencing leisure. Furthermore, a method of organizing text messages in a message stack is provided.

The current application claims a priority to the U.S. Provisional Patent application Ser. No. 61/955,125 filed on Mar. 18, 2014, and to the U.S. Provisional Patent application Ser. No. 61/981,781 filed on Apr. 19, 2014.

### FIELD OF THE INVENTION

The present invention relates generally to processing media data. More particularly, the present invention relates to facilitating convenient user communication over a network through detecting media data and through organizing messaging over the network.

### BACKGROUND OF THE INVENTION

The following background information may present examples of specific aspects of the prior and existing solutions (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Some users of electronic devices may seek an energy efficient, minimally distracting method of communicating with other users through devices. In many instances, users may seek an option which allows them to automatically connect with users having similar interests. Additionally users may seek a way of staying connected with other users without the intrusion and bombardment of current social media solutions. The invention seeks to connect users to their network while users experience leisure such as entertainment leisure in a manner such as to contain the potentially bombarding social media interactions during this window of opportunity. In addition media companies may desire to advertise relevant media content to users while users are consuming relevant media. Also media companies owning a certain platform may want to connect its users to other users who do not own the platform and so a more universal approach is needed. Again users who are experiencing leisure as is the case when consuming entertainment media, may find it most desirable to connect with other users during this leisure rather than during the busy schedule of day to day activities. Similarly, users may find it most appropriate to connect to other users on a network when the other users on the network are experiencing leisure such as is the case when consuming entertainment media and would much prefer a system that discloses this leisure information about the third party as opposed to present systems that simply detects and discloses presence.

Furthermore, a visual media window (i.e. from a live incoming video chat) floating on top of a background activity may distract users from background activity (such as playing a video game in the background) and so it may be desirable to display the visual media window only as necessary (i.e. only display window when user on the other end is talking). In addition, video and audio data such as from a live video chat being transmitted through a server network may consume a good deal of server resources and so an efficient and cost friendly manner of transmitting the data may be implemented. To this end the invention may seek to process the resulting media (such as video and or audio) data from a live video chat to determine speech activity such as when the user is talking, laughing, etc. and only transmit the video and/or audio data to at least one other user on the network when speech activity is detected. Thus the potentially continuous transmission of video and/or audio data is segmented thereby minimizing cost and server resources.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows a method of determining presence information about at least one entity based on certain criteria relating to presence. By way of educational background, another aspect of the prior art generally useful to be aware of shows devices which may be automatically signed in to web-based services based on recognition of a mobile phone as a trusted device, without requiring a customer to enter a username or password. Yet another such aspect of the prior art teaches of a system in which if a condition of automation sign-in is enabled when a user starts a software application, the sign-in prompt is bypassed and a client computer signs in to the software application without intervention from the user. However, these solutions may not provide a system for allowing users to effectively connect to other users having similar interests or connect users who are experiencing downtime through leisure based on detection of a user's activities. A solution which did so would be desirable.

Another aspect of prior and existing solutions generally useful to be aware of shows messaging applications sending user status over a network. In addition an availability is predefined for the status selected. For example an “in a meeting” selection pre-defines the user as unavailable or an “online” status signifies the user as available. However, these pre-defined notions may not always hold true. In addition these solutions may not provide a system for allowing users to uniquely define their own availability for any selected status on a whim. As a non-limiting example of the current invention's ability, Mel's status may be that he is mobile gaming. He may either select the “Mobile Gaming” status from a status repository and select (Unavailable) or select the same “Mobile Gaming” status from the drawer and select (Available). Mel may easily on the fly switch between unavailable or available for the same status selection “Gaming”. The advantage here is that there are certain status that a user can select that are neutral in their availability identification. The user may either be unavailable and doing an activity or available and doing the same activity.

Another aspect of prior art generally useful to be aware of shows messaging applications displaying how long a user's status has been active. However, these solutions may not provide a means for the user to assign an expiration to the selected status, such as but not limited to assigning a 2 hr. expiration to a status, sending and updating this expiration over a network to other users in real time and automatically expiring the status or sending a prompt to the user to expire the status after the 2 hr. limit has been reached.

Another aspect of the prior art shows a status drawer loaded with pre-defined and user defined status selections. However, these solutions do not allow the drawer to be automatically loaded with most relevant activities that may reflect a user is doing. As a non-limiting example, a user may be mobile gaming. It may be desirous for the user to have a “Mobile Gaming” or other relevant media related statuses automatically populate a status repository when it is detected that the user may be performing this activity. In addition, for the same example, again a user may be gaming and in communication or desire to communicate with another individual on the network using an avatar based video chat. The prior art does not allow a drawer to be automatically loaded with relevant characters from the game based on media detection such as detecting the game in play and loading the drawer with one or more characters from the detected game for quick and easy selection by the user.

In view of the foregoing, it is clear that these traditional techniques are not perfect and leave room for more optimal approaches.

### BRIEF DESCRIPTION OF THE DRAWINGS

FIG. 1 is a stepwise flow diagram depicting the general process of the present invention.

FIG. 2 is a stepwise flow diagram depicting steps for logging into and terminating the network application based on media detection.

FIG. 3 is a stepwise flow diagram depicting steps for detecting a media event.

FIG. 4 is a stepwise flow diagram depicting steps for generating and displaying a media-specific status description.

FIG. 5 is a stepwise flow diagram depicting steps for utilizing availability identifiers with a media-specific status description.

FIG. 6 is a stepwise flow diagram depicting steps for utilizing the status repository.

FIG. 7 is a stepwise flow diagram depicting steps for creating and utilizing a custom status description.

FIG. 8 is a stepwise flow diagram depicting steps for utilizing a communication module to show and hide a video chat window.

FIG. 9 is a stepwise flow diagram depicting steps for organizing messages into a message stack.

FIG. 10 is an illustration of exemplary components of a device for detecting and/or processing data, in accordance with an embodiment of the present invention

FIG. 11 is an illustration of an exemplary method for receiving and replying to messages, in accordance with an embodiment of the present invention.

FIG. 12 is a block diagram depicting an exemplary client/server system which may be used by an exemplary web-enabled/networked embodiment of the present invention.

FIG. 13 illustrates a block diagram depicting a conventional client/server communication system.

FIG. 14 illustrates a block diagram depicting a manual method for assigning a user defined availability identifier, a user defined expiration of a status and sending these parameters over a network. In addition, the block diagram also illustrates the blocking or disabling of singular mode stacked messaging from appearing on a device screen based on the user defined availability identifier.

FIG. 15 illustrates a block diagram depicting a method for auto loading a status drawer with one or more predefined status such as activities related to media detected and processed on a device or another device on a network connected to the device, assigning a unique user defined availability identifier to the status and automatically flushing or removing one or more auto loaded status from the drawer based on media detection and processing. Also depicted in the block diagram is the detection and processing of media in order to load and flush an avatar drawer with selection related to the media detected.

FIG. 16 illustrates an example of the present invention implemented on an electronic device such as a tablet giving a user the ability to assign an expiration and an availability identifier to one or more items in a status drawer.

FIG. 17 further illustrates an example of the present invention being implemented on two or more devices on a network. The user's status, status expiration and availability identifier after selected by the user are sent over the network to another device on the network which may or may not be related to the user.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a method of managing social media distractions over a social networking application. More specifically, the present invention depends on detection of an active media event such as a video being watched, a video game being played, or music being listened to in order to trigger actions such as generating a custom status description related to the media event or initiating communications with another user on the social networking application. The present invention is intended for use on a computing device, such as, but not limited to, a personal computer, a mobile phone, a tablet or another computing device with adequate processing power and user interface, hereinafter referred to as the device.

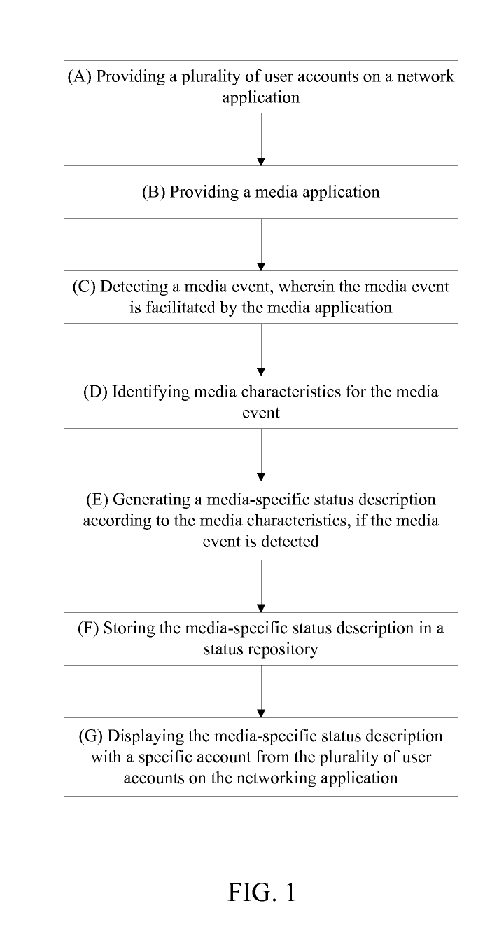

In the general method of the present invention depicted in FIG. 1, a plurality of user accounts are provided on a networking application (A). The networking application provides users with means for socially interacting with each other over a network connection such as, but not limited to, the internet. Users may write messages which other users can see in the form of broadly viewable messages (status updates or status descriptions), direct user to user messages, group messages or other types of messages. The users may additionally communicate with each other over the networking application through means such as, but not limited to, audio or video chat.

Additionally, a media application is provided (B). The media application may take many forms and embodiments. In a non-limiting example, the media application may be a digital video player utilized for playing video files. In another non-limiting example, the media application may be a music player. In another non-limiting example, the media application may be a gaming application. In another non-limiting example, the media application may be a video communication application. Similarly herein, the word “media” may refer to types of entertainment or communication such as, but not limited to, videos, music, podcasts or other audio files, video games, video chat, or other types of media. The utilization of such a media and/or media application is referred to as a media event—playing a video on the device, playing music on the device, playing a game on the device, or video chatting on the device, or another type of utilization of media or media application. Each media event is facilitated by a corresponding media application.

The preferred embodiment of present invention comprises media detection software which is preferably capable of not only identifying that a media event is occurring, but also identifying the specific media of the media event and characteristics of the media event. The media detection software preferably runs at a background priority level on the device in order to conserve device resources. When the media detection software detects a media event, one or more of several events may happen.

In the preferred embodiment, the media detection software facilitates automatic generation of a status depending on the media event. When a media event is detected (C), media characteristics are identified for the media event (D). A media-specific status description is generated according to the media characteristics (E) if the media event is detected. Subsequently, the media-specific status description is stored in a status repository (F), and the media-specific status description is displayed with a specific account from the plurality of user accounts on the networking application. It should be understood that the specific account is associated with a specific user. References to the user should be understood to be correspondingly referencing the specific account, and vice versa.

The media-specific status description is a written description of the status of the user's current activity. The media characteristics are any characteristics of a media item, such as, but not limited to, the title of the media item, the length of the media item if the media item is a video or audio file, the author or publisher of the media item, whether the user has engaged with the media item before, or any other relevant characteristics. The status repository may also be known as a “status drawer” and may contain one or more media-specific status descriptions which a user of the present invention may manipulate in various manners as described later herein. The status repository provides the user to choose from a variety of options for choosing status descriptions. The specific account is the account the user logs into on the networking application.

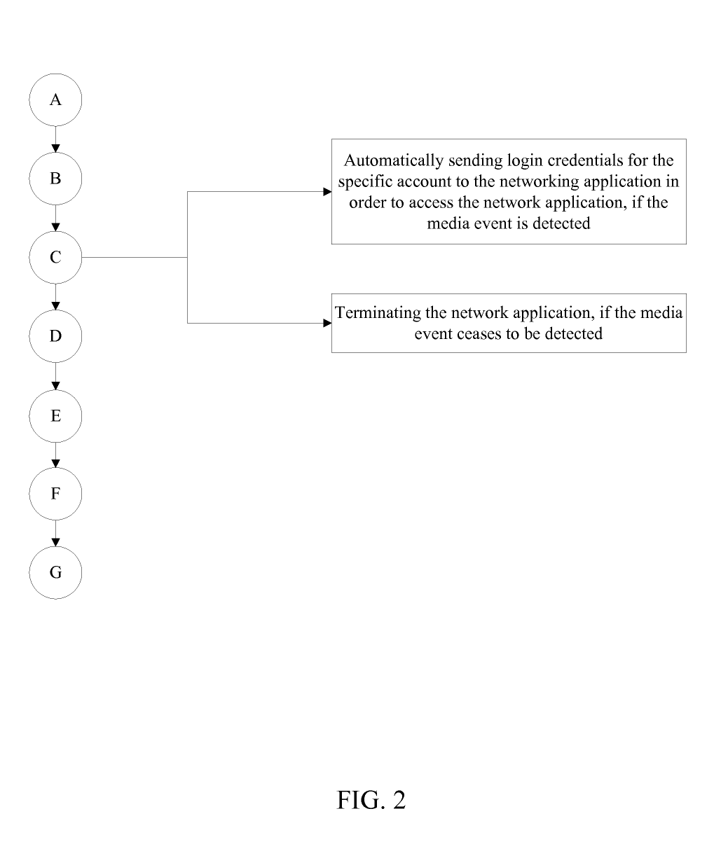

In one embodiment of the present invention, the networking application is automatically initialized upon detection of the media event. To this end, if the media event is detected, login credentials for the specific account are automatically sent to the networking application in order to access the networking application, as depicted in FIG. 2. Additionally, in one embodiment the networking application is terminated on the device if the media event ceases to be detected.

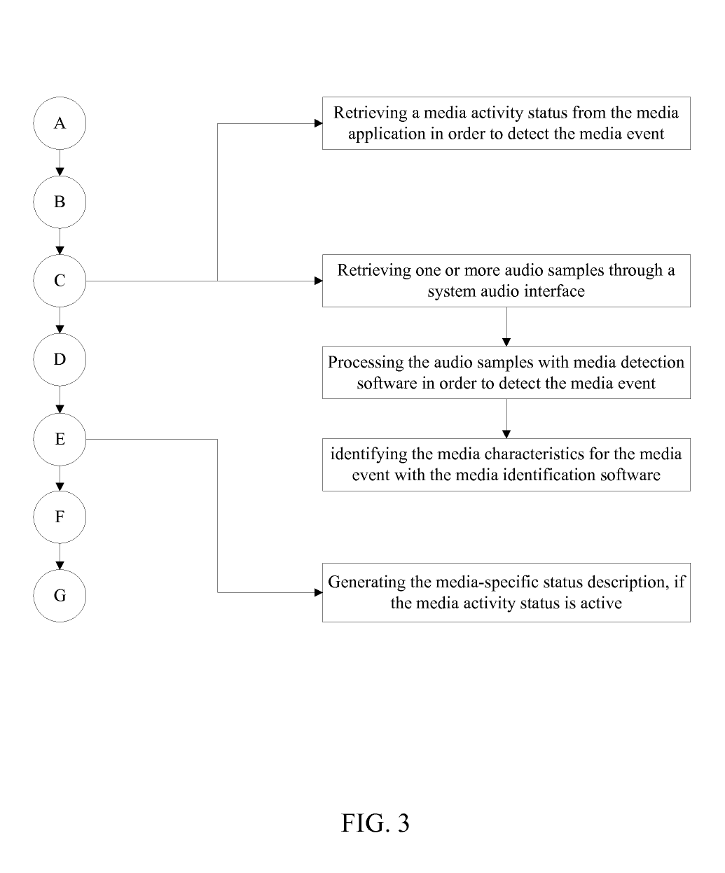

In reference to FIG. 3, in one embodiment of the present invention, in order to detect the media event, a media activity status is retrieved from the media application in order to detect the media event. The media-specific status description is subsequently generated if the media activity status is active.

In another embodiment, one or more audio samples are retrieved through a system audio interface. The audio samples are processed with the media detection software in order to detect the media event, and the media characteristics of the media event are identified with the media identification software. In this embodiment, the media detection software comprises algorithms for analyzing audio samples in order to detect that firstly, the audio samples are samples of a media item and secondly, analyzing the audio samples in order to specifically identify the media item. For example, if the media item is a musical audio file, the media detection software first identifies the media item as a musical audio file, and subsequently identifies the musical audio file as a specific musical audio file.

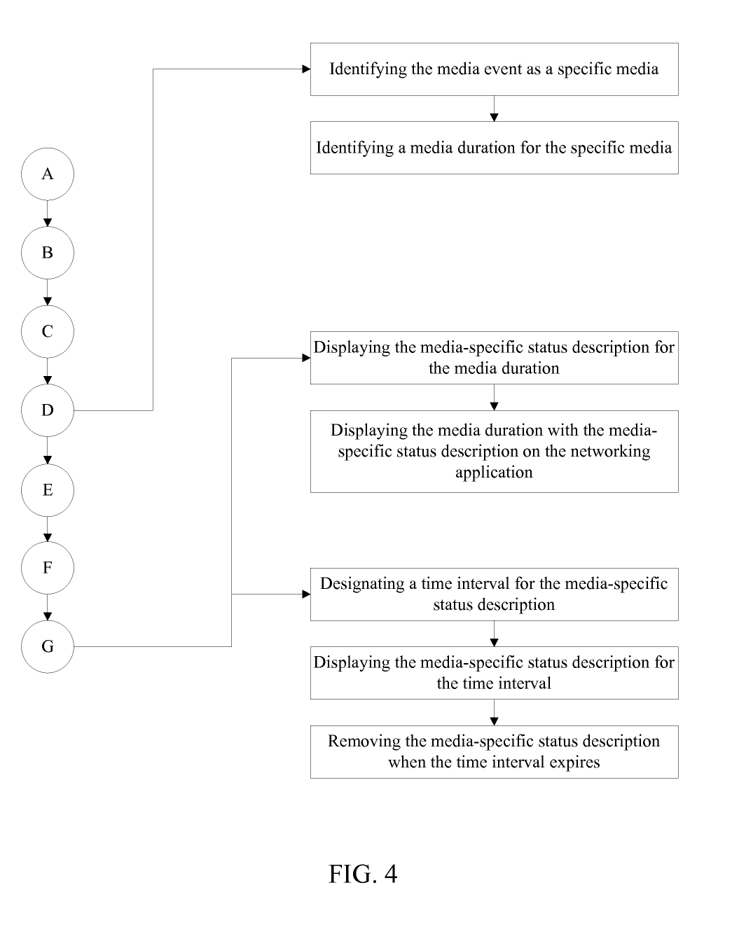

Referring to FIG. 4, in one embodiment, after the media event is identified as a specific media item, a media duration is identified for the specific media item as one of the media characteristics. After the media-specific status description is generated from the specific media item, the media-specific status description is displayed for the media duration. In one embodiment the media-specific status description is displayed for the media duration in function only. In another embodiment the media duration is displayed with the media-specific status description on the networking application. In a non-limiting example, in the first aforementioned embodiment, the media-specific status description may be defined as “[user] is watching [movie title]” while in the second aforementioned embodiment, the media-specific status description may be defined as “[user] is watching [movie title] for [media duration].”

In a related aspect of the present invention, the user may customizably designate a time interval for the media-specific status description. In this case, once the user chooses a media-specific status description, the user may decide how long they want the media-specific status description to be displayed, and assign the desired time interval to the media-specific status description. The media-specific status description is displayed on the networking application for the time interval, and the media-specific status description is removed when the time interval expires. It should be noted that the aforementioned aspect of customizably designating a time interval for a status description should not be limited to media-specific status descriptions and may also apply to non-media-specific status descriptions, such as but not limited to custom status descriptions.

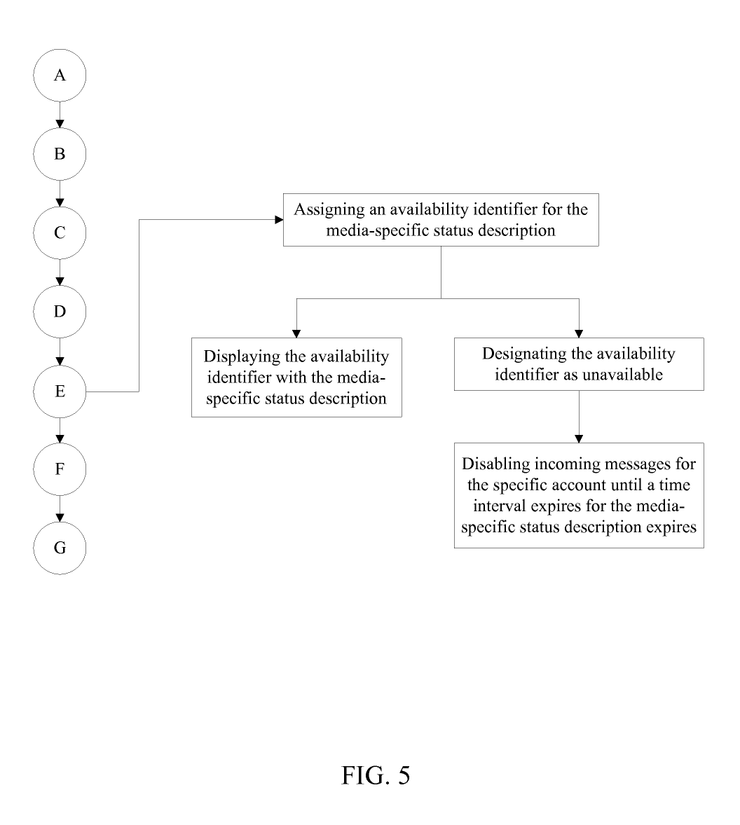

Referring to FIG. 5, another aspect comprised in the preferred embodiment of the present invention is the ability to designate an availability identifier to a status description. After the media-specific status description is generated, the user may assign an availability identifier to the media-specific status description. The availability identifier is then displayed with the media-specific status description on the networking application. The availability identifier is an indicator of whether or not the user wishes to potentially interact with other users. If the availability identifier is designated as an unavailability descriptor, incoming messages may be disabled for the specific account until a time interval for the media-specific status description expires, or until the user changes the availability identifier to an availability descriptor, or until the media-specific status description is removed in another manner not mentioned herein. As with the time interval, it should be noted that the availability identifier feature is not limited to media-specific status descriptions, and may also apply to non media-specific status descriptions, such as but not limited to custom status descriptions.

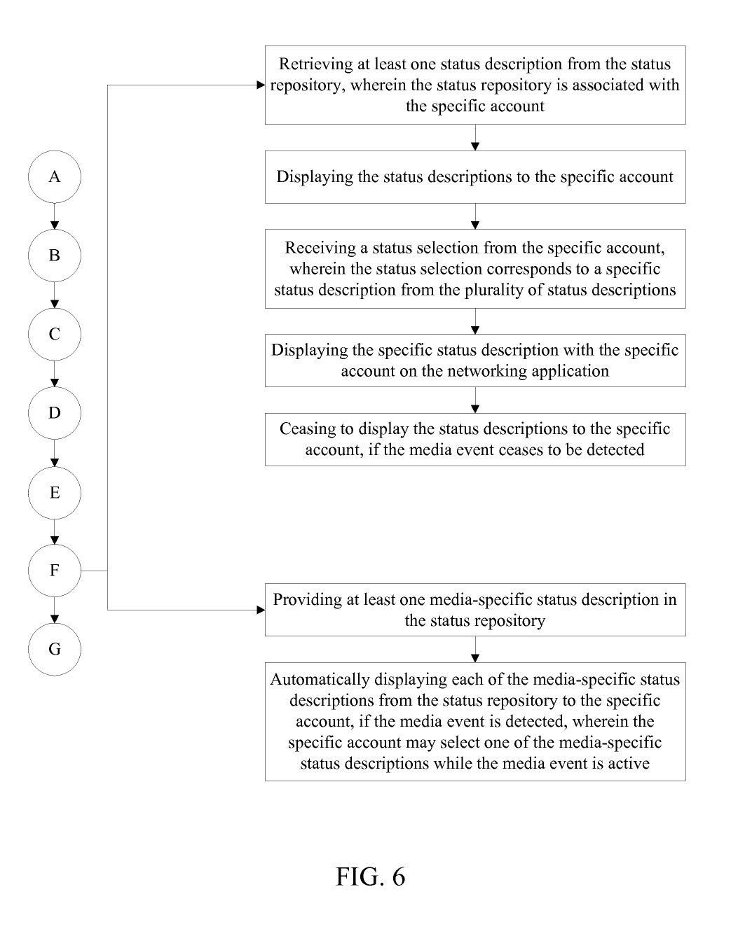

In reference to FIG. 6, as previously mentioned, the present invention comprises a status repository, also known as a status drawer. The status repository comprises a visual representation of a plurality of options for selecting a status description to display on the networking application. In the preferred embodiment, the status repository is automatically displayed to the specific account when the present invention detects a media event. Alternatively, the status repository may also be displayed to the specific account upon user input to show the status repository.

In another embodiment, the status repository may be initialized but hidden from the specific account when the present invention detects a media event. In this same embodiment an object that offers the least distraction may be used to alert the user of the media detection event and may appear and prompt the user to select a media-specific status from the status repository. In a non-limiting example, the object may be a status drawer handle located at the edge of the device screen offering least distraction. To continue upon performing a certain action towards the object such as but not limited to swiping or tapping the object, the status repository may transition from a hidden mode to an unhidden mode such that the user may select the relevant media-specific status from the repository.

To utilize the status repository, at least one status description is retrieved from the status repository, wherein the status repository is associated with the specific account. The status descriptions are displayed to the specific account, and a status selection is received from the specific account. The status selection corresponds to a specific status description from the plurality of status descriptions. The specific status description is then displayed with the specific account on the networking application. The status selection may correspond to a media-specific status description, to a custom status description, a dynamic status description, or any other status description from the status repository or from another location. In the preferred embodiment, the status repository and the status descriptions are displayed to the specific account for the duration of the media event. The user however may be provided with an option to hide the status descriptions.

In many embodiments media data may be continually sampled and/or processed in an efficient manner in order to determine if the media event is still occuring. In one embodiment once the media data processed validates that the media event is no longer occurring, the media detection software may signal the application to expire the media-specific status description displayed with the specific account on the network. In another embodiment, once the media event is no longer valid, the media detection software may signal the network application to hide the media specific status or a plurality of media-specific statuses from the user such as preserve space inside the status repository. In the same embodiment the user may have the option to unhide the hidden media-specific status description or a plurality of media specific status descriptions such as a list of media-specific status descriptions in the status repository, by tapping on or performing a similar action towards an object representing the hidden mode of the media-specific status descriptions in the status repository.

In another embodiment, once the present invention detects that the media event is no longer occurring, it may signal primary services for the specific account within the networking application such as media display, networking, user communication, and so on to stop running, thereby only connecting the user to the network only when the media event is detected and preserving battery life on computer appliances such as mobile devices. In another embodiment, the present invention while terminating other services within the application to preserve battery life may keep network services for the specific media account running such that the user may continually receive media communication such as but not limited to notifications, text, video or picture messages, etc. from at least one other account on the network in an efficient manner.

In all such embodiments once the media event is no longer detected by the application, the application may issue commands to wait for a certain time duration before terminating any application services, logging the user out of the network or expiring the media-specific status associated with the specific user account from the network. As a non-limiting example the application may wait 5 minutes after the media event is no longer detected or valid. If a media event is no longer detected or validated before the 5 minute threshold is met then the application may commence terminating any application services, logging the user out of the network or expiring the media-specific status associated with the specific user account from the network.

In one embodiment, while the user is engaged with the media event, at least one media-specific status description is provided in the status repository. Each of the at least one media-specific status descriptions is automatically displayed to the specific account if the media event is detected so that the user of the specific account may select one of the media-specific status descriptions while the media event is active. This allows the user, while engaged with the media event, to select from one or more status descriptions relevant to the media event. Preferably, in this embodiment, the status descriptions cease to be displayed to the specific account if the media event ceases to be detected. In other words, the status drawer is displayed to the user only while the user is engaged with the media event. In other embodiments, the status descriptions may not be automatically displayed to the user.

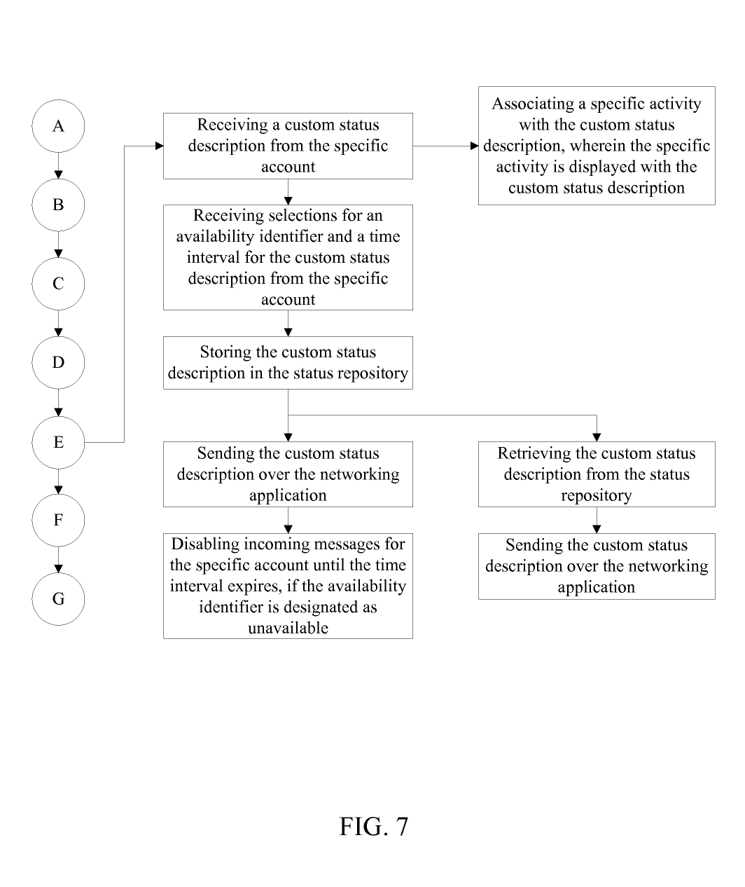

Referring to FIG. 7, in the preferred embodiment the user also has the ability to create a custom status description that is not automatically generated or related to a media event. A custom status description may be received from the specific account in order to create the custom status description. Along with the custom status description, as previously described, selections may be received from the specific account for an availability identifier and a time interval for the custom status description. The custom status description may then be stored in the status repository, or may be discarded after use.

In one embodiment, an additional option provided to the user is the ability to associate a specific activity with the custom status description to be displayed with the custom status description. The specific activity may be related to a media event as described previously, but is not necessarily related to a media event. In a non-limiting example, the specific activity may be defined as an activity such as, but not limited to, watching a movie, playing a game, engaging in a video chat, reading an article on a website, doing homework, programming an application, doing graphic design work, or other activities.

After the custom status description is fully defined by the user, the custom status description is sent over the networking application for other users to see. In some various embodiments, the custom status description may be discarded after use, or the custom status description may be stored within the status repository for retrieval and re-use in a future instance.

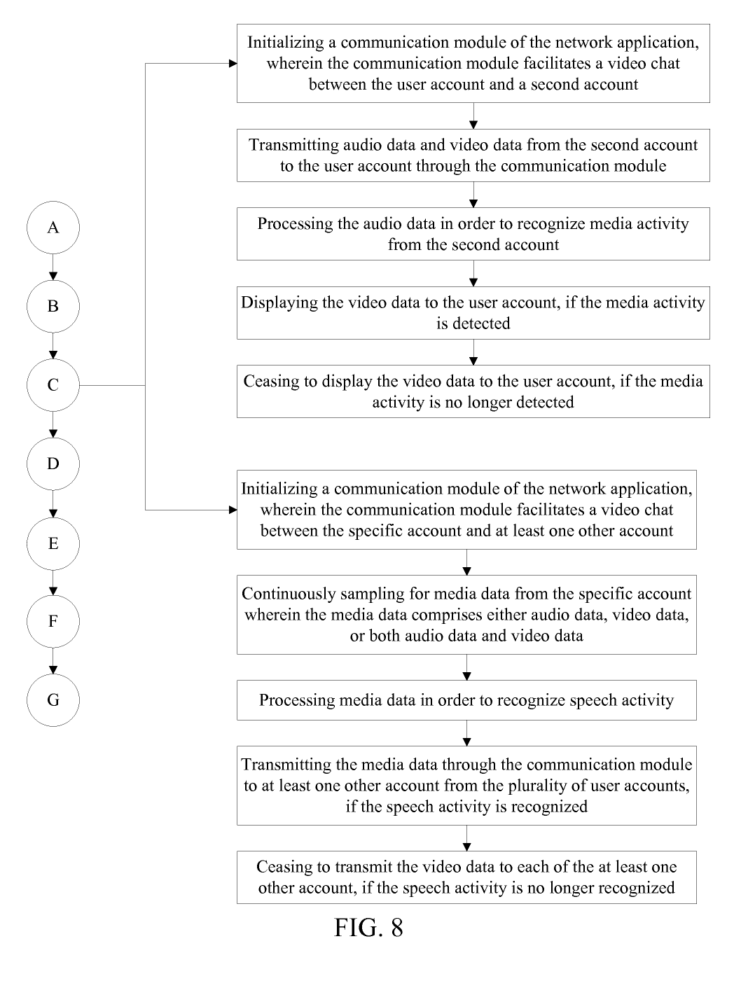

Referring to FIG. 8, an additional feature and embodiment of the present invention relates to video communication between two users. The purpose of this feature is to manage the video communication by only displaying video data of a user while the user is speaking. This minimizes distractions while the communicating users are engaging with a media event. In addition, this feature may minimize server resources and cost related to streaming video over the network. To this end, a communication module is comprised by the network application, wherein the communication module facilitates video communication between the two users. In various embodiments, the communication module may also be responsible for facilitating text or audio communication between users.

In one embodiment of the present invention, the communication module may be initialized manually. In another embodiment, the communication module is automatically initialized upon detection of a media event. A connection is established between the user account and at least one other account from the plurality of user accounts through the communication module.

In one embodiment, audio data and video data are transmitted from one of the at least one other accounts to the user account through the communication module. The audio data and/or video data is processed in order to recognize media activity from the second account, wherein the media data in this case is audio samples and/or video samples of the user of the second account speaking, laughing or otherwise engaging in the video communication. If the media activity is detected and recognized as speech activity, the video data is displayed to the user account, preferably in a visual media window. If the media data is no longer detected, the video data ceases to be displayed to the user account. In other words, in this embodiment, the specific account continually receives the media data of the second account, but the media data is only displayed on the device when the second account is recognized to be engaging in speech activity. In the present embodiment, the media data is processed on the device of the recipient. Additionally, in the preferred embodiment, a media communication controller of the device is utilized to start and stop displaying the media data in the visual media window.

In another embodiment, the communication module is initialized in order to facilitate a video communication between the specific account and at least one other account. In this embodiment, the present invention samples for media data from the specific account. The media data from the specific account comprises either audio data, video data, or both audio data and video data. The media data is received by the device from the user through input devices such as, but not limited to, a microphone, a camera, or both.

The media data is processed in order to recognize speech activity from the user account. In one embodiment, the audio data of the media data is processed with speech recognition software in order to recognize the speech activity. In another embodiment, the video data is processed with facial recognition software in order to recognize speech activity. In still another embodiment, both the audio data and the video data are processed to recognize the speech activity. If speech activity is recognized, the media data is transmitted through the communication module to one of the at least one other accounts. If the speech activity is no longer recognized, transmission of the media data to each of the at least one other account is ceased. In other words, in this embodiment, the media data of the user account is only transmitted over the network to the at least one other account if the user is recognized to be engaging in speech activity. The processing is done on the sender's device, the device of the user of the specific account. Additionally, the visual media window displaying the media data is only displayed to the user account while the speech activity is recognized. This is done to preserve space on the display of the device and to be minimally intrusive to the user in a multitasking environment.

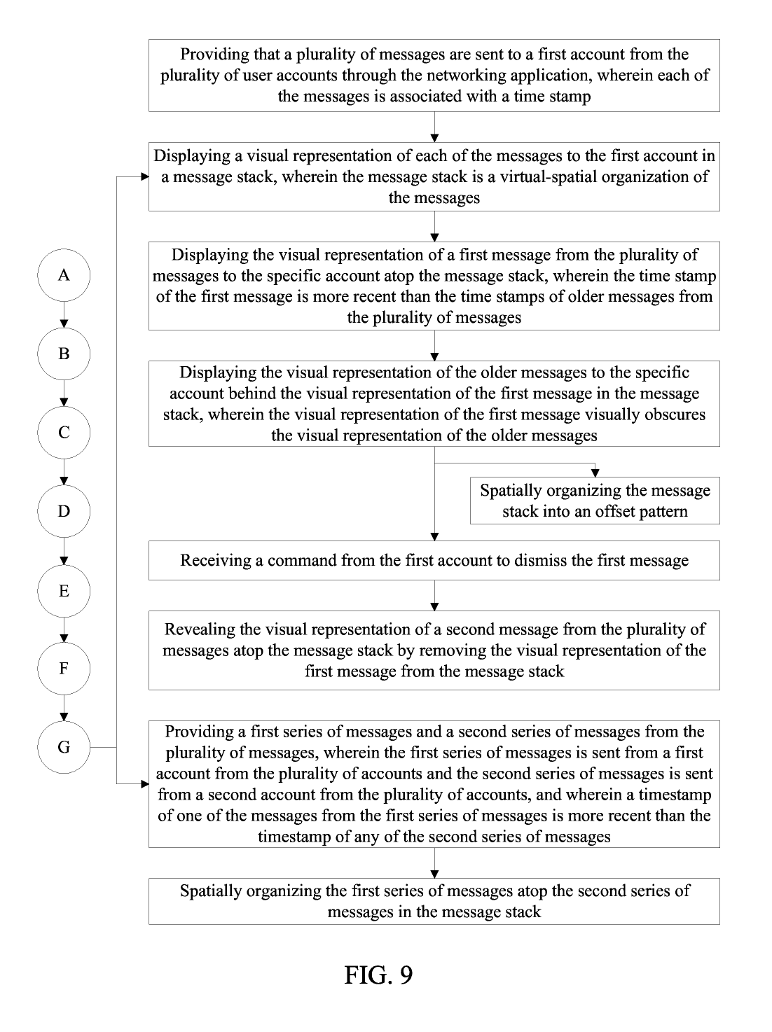

Referring to FIG. 9, another feature comprised by preferred embodiment of the present invention is a message organization feature. This feature relates to receiving multiple messages from multiple other user accounts. In a non-limiting example, a plurality of messages are sent to the specific account from the plurality of user accounts through the networking application. Each of the plurality of messages is associated with a time stamp.

A visual representation of each of the messages is displayed to the specific account in a message stack, which is a virtual-spatial organization of the messages. The visual representation of a first message from the plurality of messages is displayed atop the message stack, wherein the time stamp of the first message is more recent than the time stamps of older messages from the plurality of messages. The visual representations of the older messages are displayed to the specific account behind the virtual representation of the first message in the message stack, wherein the visual representation of the first message visually obscures the visual representation of the older messages.

In one embodiment, the first message entirely obscures the older messages, so that only one of the plurality of messages can be seen at once. In another embodiment, the message stack is spatially organized into an offset pattern.

In order to manage the messages, a command from the specific account may be received to dismiss the first message. Subsequently, the visual representation of a second message from the plurality of messages is revealed atop the message stack by removing the visual representation of the first message from the message stack.

In some cases, the user may receive multiple messages from multiple other users. In this case, a first series of messages and a second series of messages are provided from the plurality of messages. The first series of messages is sent from a first account from the plurality of user accounts, and the second series of messages is sent from a second account from the plurality of user accounts, wherein the timestamp of one of the messages from the first series of messages is more recent than the timestamp of any of the second series of messages. In other words, the message and associated series of messages with the most recent timestamp is always displayed to the user first. The first series of messages is spatially organized atop the second series of messages in the message stack.

The following is a non-limiting example of the functionality of the previously described message stack organization feature. In the case of receiving and replying to messages, the manner in which the messages are arranged on screen may resembles a stacked deck of cards such as in a manner that only fully displays one message at a time. The order of the sorting may be as follows:
most recent sender first and associated messages in chronological order;
reply message to most recent sender;
next most recent sender and associated messages in a chronological order;
reply to next most recent sender;
last sender and associated messages in a chronological order;
reply to last sender;

In another embodiment priority may be assigned to one or more users from a recipient's contacts, thus precedence may be given these users during the sorting. In such case the sorting may be:
priorty user(s) first and associated messages both in chronological order;
reply to priority users;
most recent sender and associated text messages in chronological order;
reply to most recent sender;
next most recent sender and associated messages in chronological order;
reply to next most recent sender;
last sender and associated messages in chronological order;
reply to last sender;

Although the invention has been explained in relation to its preferred embodiment, it is to be understood that many other possible modifications and variations can be made without departing from the spirit and scope of the invention as hereinafter claimed.

Additional description;

The following is a secondary detailed description intended to supplement the above detailed description.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor- based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, Firefox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM™ MQSeries™ technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer- executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments of the present invention may provide means and/or methods for detecting and/or processing of data. Some of these embodiments may provide computer software for integration with electronic devices, including, without limitation, smartphones, tablets, laptops, game consoles, Desktop Computers, Electronic Music Keyboards, Smart TV(s), etc. In some embodiments, embodiment software may be suitable for use with various platforms, including, without limitation, IOS, Android, and Windows Desktop, Linux, Windows Server, etc. In one or more embodiments, embodiment software may be similar or identical for various platforms. In a non-limiting example, embodiment software may be functional on both a smartphone and a tablet.

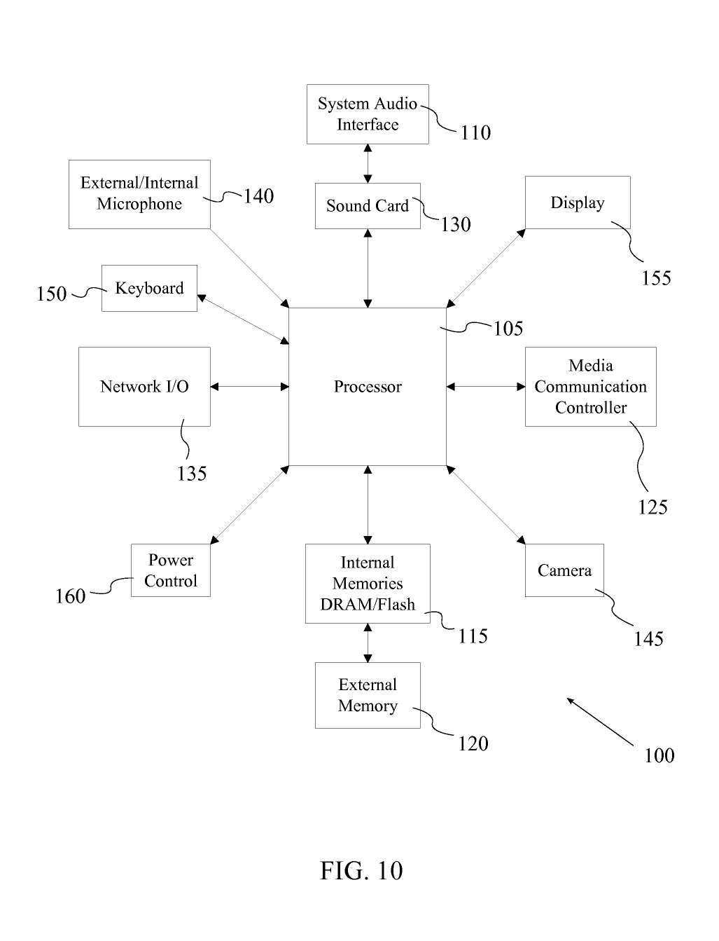

FIG. 10 is an illustration of exemplary components of a device 100 for detecting and/or processing data, in accordance with an embodiment of the present invention. In the present embodiment, a device 100 may have a processor 105. In some embodiments, processor 105 may be suitable for interfacing with other components. In a non-limiting example a processor 105 may interface with other systems on a device to process instructions related to singular mode stacked messaging, in order to send and receive messages. In a non-limiting example, a processor 105 may interface with a system audio interface 110 and internal 115 and/or external 120 memory to sample and/or process media data such as but not limited to audio from a device 100. In the present embodiment, a media communication controller 125 may be an application on a device 100 which may engage processor 105 to control various systems of device 100 related to detecting media such as but not limited media such as audio, video, text data, data embedded in an audio stream, data embedded in video stream or any data associated with the media, data sent over a network, etc. In one embodiment, a media communication controller 125 may preload status drawer from a chat or social media networking application. In another embodiment, a media communication controller 125 may load or preload an avatar drawer from an avatar based video chat or social media networking application. In the present embodiment, processor 105 may communicate with a sound card 130 to detect sample audio data. In some embodiments, sampled audio data may be stored for processing on device 100 memory components. In many embodiments, processor 105 may execute processing of stored data to validate such data. In another embodiment processor 105 may communicate with a media controller to control various systems and operations on a computer device related to media detection and processing. In another embodiment the processor may engage a native component of an operating system in order to detect the media. As an example, some mobile operating systems such as android have the ability to detect if an application have engaged the operating system's music or media player, thus the current invention may make use of this native detection capability of the operating system rather than sample the raw media. Some non-limiting examples of media may include, audio, video data from an audio stream, data embedded in a video stream or other data related to media being detected, data being streamed over a network, etc. In some embodiments, media communication controller 125 may issue commands to pre-load a status drawer with status selections and information related to the media detected. In another embodiment the same controller may issue commands to pre-load an avatar drawer with selections and information related to the media detected. In the present embodiment, a device network I/O 135 may enable communication between devices. In a non-limiting, a device network I/O 135 may enable communication between a device 100, a server application, and one or more devices in a network. In the present embodiment, device 100 may use an internal and/or external microphone 140, a video camera 145, and/or a keyboard 150 to support communication between devices. In a non-limiting example, a microphone 140, a video camera, and a keyboard may support audio and/or visual communication between device 100, a server application, and/or one or more devices in a network. In the present embodiment, device 100 may use a display 155 to detect visual media.

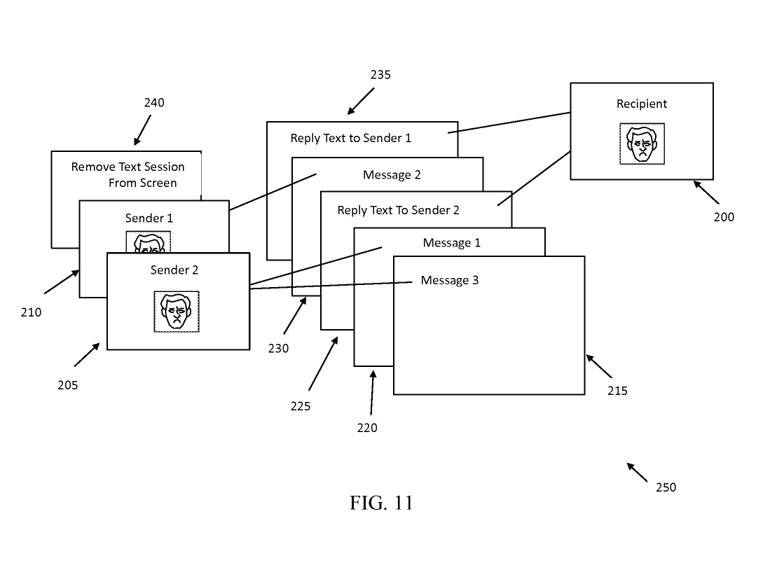

FIG. 11 is a block diagram depicting a non-limiting exemplary method of executing singular mode stacked messaging for multiple messages received from multiple senders. In a non-limiting example, sender 2 205 sends the first message 220 to a recipient 200. Sometime after Sender 1 210 sends a second message 230 to recipient 200. A third message 215 is again sent to recipient 200 by sender 2 205. Sometime later recipient 200 encounters the messages sent by sender 1 210 and sender 2 205. In some embodiments the arrived messages are re-arranged on the recipient's 200 in a manner that is most efficient. The order of the sorting maybe as follows: Most recent sender first and associated text messages chronologically arranged; Reply embodiment to most recent sender; Next most recent sender and associated messages chronologically arranged; Reply embodiment to next most recent sender; Last sender and associated messages chronologically arranged; Reply embodiment to last sender; In another embodiment, messages may also be ordered from oldest sender first to most recent sender last and associated messages. In yet another embodiment, priority may be assigned to one or more users from a recipient's contacts, thus precedence may be given these users during the sorting. In such case the sorting may be: Priorty users first in chronological order and associated Text also in chronological order; Reply embodiment to priorty users; Most recent sender next and associated text messages in chronological order; Reply embodiment to Most recent sender; Next most recent sender and associated messages in a chronological order; Reply embodiment to next most recent sender; Last sender and associated messages in a chronological order; Reply embodiment to last sender;

In one embodiment the messages are arranged or accessed in a singular mode. In a non-limiting example Message 3 215 being the most recent message sent by sender 2 205 becomes the first message 215 shown or fully shown on the recipient's 200 device along with a (visual representation of sender 2) 205. After accessing Message 3 215 recipient 200 may access the next message (Message 1 220) sent by Sender 2 205 by tapping on message 3's embodiment 215 or engaging the message embodiment or another related object on screen by means of another gesture in order to dismiss Message 3 and reveal Message 1. In one non-limiting example Message 1's embodiment 220 from sender 2 appears and occupies the same space as Message 3 previously occupied on screen, so that it may appear as though message 3 was stacked on top of Message 1. In another embodiment Message 1's embodiment 220 from sender 2 may be hidden behind Message 3 215 at an offset such as to partially reveal Message 1. This may be used as a visual aid in order to make it apparent to the user that message 1 is stacked behind Message 3. 1. In a non-limiting example, recipient 200 may reply to the messages sent by Sender 2 205, by tapping on message 1's embodiment 220 or engaging the message embodiment 220 or another related object on screen by means of another gesture in order to dismiss Message 1 220 and reveal or access the reply message embodiment 225 to sender 2. In one non-limiting example the reply message embodiment 225 appears and occupies the same space as Message 1 previously occupied on screen, so that it may appear as though message 1 was stacked on top of the reply Message embodiment 225. In another non-limiting embodiment the reply message embodiment 225 to sender 2 may be hidden behind Message 1 220 at an offset such as to partially reveal the reply message embodiment 225. This may be used as a visual aid in order to make it apparent to the user that the reply message embodiment is stacked behind Message 1. In another non-limiting example recipient 200 may dismiss or bypass Message 3 and Message 1 from sender 2 205 without reading, by tapping on the visual representation of Sender 2 205 or engaging the visual representation of Sender 2 205 or another related object on screen by means of another gesture. In one non-limiting example Sender 1's visual representation 210 appears and occupies the same space as Sender 2's visual representation 205 previously occupied on screen, so that it may appear as though sender 2 205 was stacked on top of sender 1 210. In another non-limiting example Sender 1's visual representation 210 may be partially hidden Sender 2's visual representation 205 as a visual aid in order to make it apparent to the recipient that there are other messages from other users to be accessed. In a non-limiting example, recipient 200 may reply to Message 2 from sender 1 210, by tapping on message 2's embodiment 230 or engaging the message embodiment 230 or another related object on screen by means of another gesture. In one embodiment, recipient 200 may dismiss or remove the entire messaging session 250 from the device screen in 240 without reading messages from either senders, by first tapping on the visual representation of Sender 2 205 to dismiss the sender and associated messages, then by tapping on Sender 1 210 to dismiss sender 1 and associated messages. In another embodiment, the recipient 200 may dismiss the entire messaging session 250 from the device screen as in 240 by engaging the embodiment 250 or another related object on screen by means of another gesture. In one embodiment the incoming messaging embodiment 250 may be blocked from appearing on the device screen by means of an availability identifier 725 from a status drawer 710 which as a non-limiting example may signal that the user is unavailable and so it is not desirous to show the message on the user's device screen. In another embodiment the blocked messages may be accessible by the user by means of notification service within a device, with an alert sent to the user. In another embodiment the blocked messages may be accessed by opening the application associated with the blocked message such as a social networking application. In either case, an alternate method is implemented to collect the message(s) blocked from appearing on the device screen in order that the blocked message(s) may be accessed at a later time when the user becomes available.

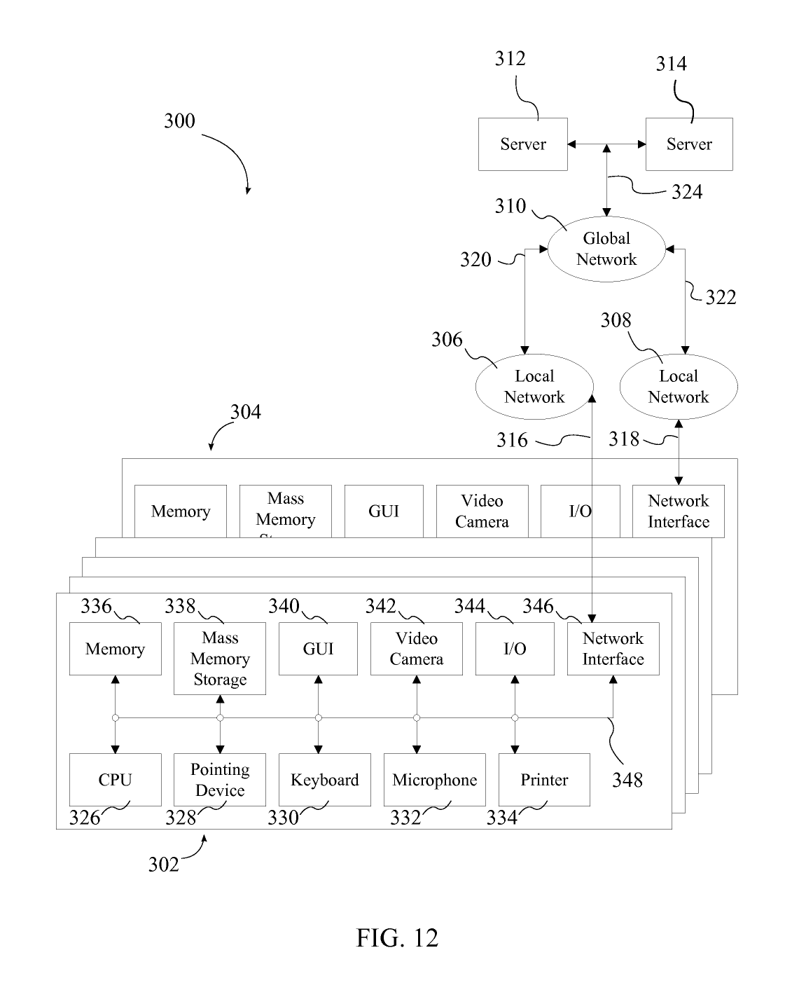

FIG. 12 is a block diagram depicting an exemplary client/server system which may be used by an exemplary web-enabled/networked embodiment of the present invention. A communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi- directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

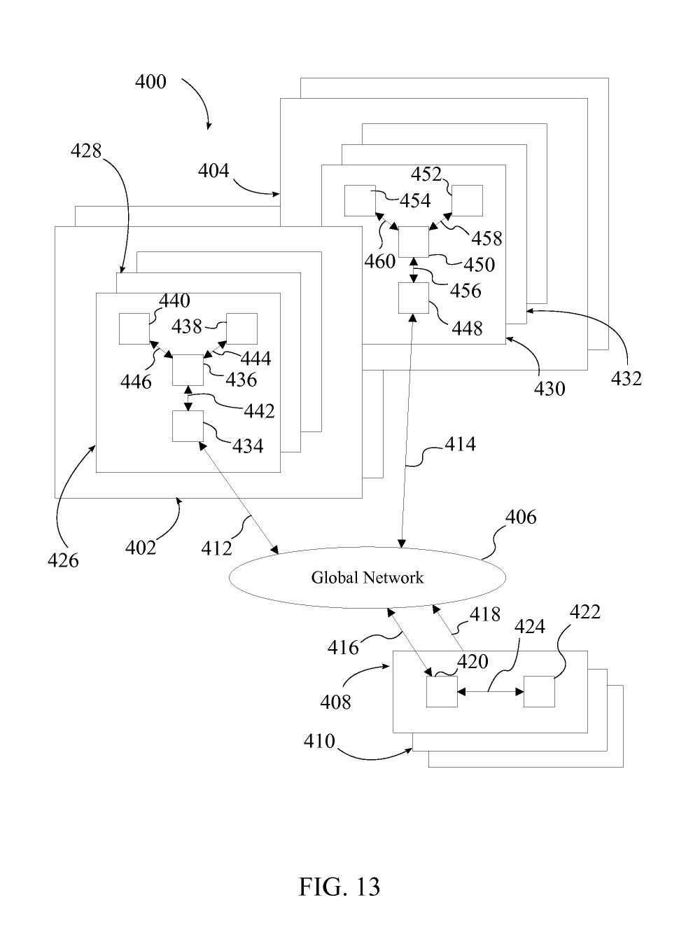

FIG. 13 illustrates a block diagram depicting a conventional client/server communication system.

A communication system 400 includes a multiplicity of networked regions with a sampling of regions denoted as a network region 402 and a network region 404, a global network 406 and a multiplicity of servers with a sampling of servers denoted as a server device 408 and a server device 410.

Network region 402 and network region 404 may operate to represent a network contained within a geographical area or region. Non-limiting examples of representations for the geographical areas for the networked regions may include postal zip codes, telephone area codes, states, counties, cities and countries. Elements within network region 402 and 404 may operate to communicate with external elements within other networked regions or within elements contained within the same network region.

In some implementations, global network 406 may operate as the Internet. It will be understood by those skilled in the art that communication system 400 may take many different forms. Non-limiting examples of forms for communication system 400 include local area networks (LANs), wide area networks (WANs), wired telephone networks, cellular telephone networks or any other network supporting data communication between respective entities via hardwired or wireless communication networks. Global network 406 may operate to transfer information between the various networked elements.

Server device 408 and server device 410 may operate to execute software instructions, store information, support database operations and communicate with other networked elements. Non-limiting examples of software and scripting languages which may be executed on server device 408 and server device 410 include C, C++, C# and Java.

Network region 402 may operate to communicate bi-directionally with global network 406 via a communication channel 412. Network region 404 may operate to communicate bi-directionally with global network 406 via a communication channel 414. Server device 408 may operate to communicate bi- directionally with global network 406 via a communication channel 416. Server device 410 may operate to communicate bi-directionally with global network 406 via a communication channel 418. Network region 402 and 404, global network 406 and server devices 408 and 410 may operate to communicate with each other and with every other networked device located within communication system 400.

Server device 408 includes a networking device 420 and a server 422. Networking device 420 may operate to communicate bi-directionally with global network 406 via communication channel 416 and with server 422 via a communication channel 424. Server 422 may operate to execute software instructions and store information.

Network region 402 includes a multiplicity of clients with a sampling denoted as a client 426 and a client 428. Client 426 includes a networking device 434, a processor 436, a GUI 438 and an interface device 440. Non-limiting examples of devices for GUI 438 include monitors, televisions, cellular telephones, smartphones and PDAs (Personal Digital Assistants). Non-limiting examples of interface device 440 include pointing device, mouse, trackball, scanner and printer. Networking device 434 may communicate bi-directionally with global network 406 via communication channel 412 and with processor 436 via a communication channel 442. GUI 438 may receive information from processor 436 via a communication channel 444 for presentation to a user for viewing. Interface device 440 may operate to send control information to processor 436 and to receive information from processor 436 via a communication channel 446. Network region 404 includes a multiplicity of clients with a sampling denoted as a client 430 and a client 432. Client 430 includes a networking device 448, a processor 450, a GUI 452 and an interface device 454. Non-limiting examples of devices for GUI 438 include monitors, televisions, cellular telephones, smartphones and PDAs (Personal Digital Assistants). Non-limiting examples of interface device 440 include pointing devices, mousse, trackballs, scanners and printers. Networking device 448 may communicate bi-directionally with global network 406 via communication channel 414 and with processor 450 via a communication channel 456. GUI 452 may receive information from processor 450 via a communication channel 458 for presentation to a user for viewing. Interface device 454 may operate to send control information to processor 450 and to receive information from processor 450 via a communication channel 460.

For example, consider the case where a user interfacing with client 426 may want to execute a networked application. A user may enter the IP (Internet Protocol) address for the networked application using interface device 440. The IP address information may be communicated to processor 436 via communication channel 446. Processor 436 may then communicate the IP address information to networking device 434 via communication channel 442. Networking device 434 may then communicate the IP address information to global network 406 via communication channel 412. Global network 406 may then communicate the IP address information to networking device 420 of server device 408 via communication channel 416. Networking device 420 may then communicate the IP address information to server 422 via communication channel 424. Server 422 may receive the IP address information and after processing the IP address information may communicate return information to networking device 420 via communication channel 424. Networking device 420 may communicate the return information to global network 406 via communication channel 416. Global network 406 may communicate the return information to networking device 434 via communication channel 412. Networking device 434 may communicate the return information to processor 436 via communication channel 442. Processor 446 may communicate the return information to GUI 438 via communication channel 444. User may then view the return information on GUI 438.

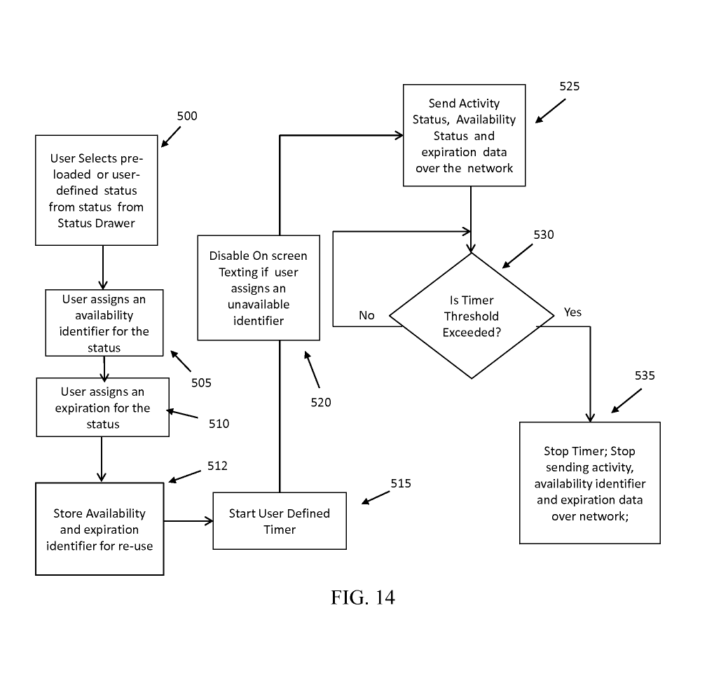

FIG. 14 is block diagram depicting a method for sending a user's status over a network. In the present embodiment a user chooses a preloaded or user defined status selection from a status drawer in 500. In addition, a user may assign a unique availability identifier in 505 for the status selection. In one non-limiting example the availability identifier in 505 may signal that the user is not available. In another non-limiting example the availability identifier in 505 may signal that the user is available from the same identifier. In any such example, the user may have the ability to assign an availability identifier to any selection in the status drawer to signal whether or not the status selected from the drawer may make the user available or unavailable. As a non-limiting example to make clear the present invention, by use of an availability identifier 505 the user may have the flexibility to assign an available or unavailable status to the same activity. To continue the non-limiting example, the user may be “mobile gaming” and not available or “mobile gaming” and available, thus flexibility may be given the user through the present invention to assign either status to the same “mobile gaming” selection from the status drawer. In one embodiment, the user may store the availability defined in step 505 for re-use in step 512 such as to spare the user from the hassle of assigning an availability identifier 505 each time the same status is selected. In some embodiments the user may also have the ability to assign an expiration in 510 for the status selected from the drawer which may be used to signal to other users on the network associated with the user sending the status how long before the status expires. In one embodiment, the user may store the expiration defined in step 510 and illustrated in 720 and 750 for re-use in step 512 such as to spare the user from the hassle of assigning an expiration 510 each time the same status is selected if desirous. A timer mechanism is started based on the user's input in 515. If the user assigned an unavailable status by means of the availability identifier in 505 then the software may disable messages from appearing on the device screen of the user sending the status in a step 520. Otherwise, messages may appear on screen if an available status is selected by means of the availability identifier or if no availability is identified. In one embodiment the user's status, availability and expiration if a status is selected from the drawer may be sent over a network in step 525 to one or more users over a network such as illustrated in 800. The timed expiration of the user status may be updated in real time to all users on the network offering on-going visibility of how much time is left before the status expires such as illustrated in 800. In one embodiment, once the timer threshold set by the user is expired or exceeded 530, the application may stop sending the activity status, the availability status and the expiration notification 535 over the network. In another, embodiment the application may signal or notify the user of the impending status expiration and query the user before stopping the status and all related components.

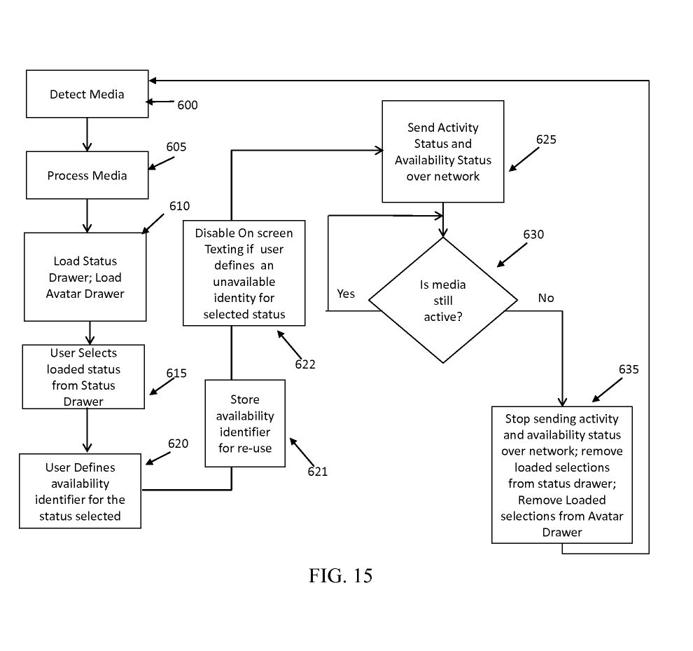

FIG. 15 is an illustration of an exemplary method for detecting and/or processing data, in accordance with an embodiment of the present invention. In the present embodiment, a device 100 may determine whether media has been detected in a step 600. In many embodiments, device 100 may be any suitable electronic device, including, without limitation, smartphone, tablet, laptop, game console, electronic musical keyboard, PC, etc. In some embodiments, the device 100 may detect media. In other embodiments, another device in a network which may be in communication with the device 100 may detect media. In some of these embodiments, another device connected to device 100 may communicate with media communication controller 125 of device 100. In the present embodiment, device 100 may process detected media in a step 605. In some embodiments, device 100 may use controller 125 to process media. Further, upon detecting and processing the media the device may signal an application and/or service to load the status drawer with status selection and/or data related to the media detected in a step 610. In a non-limiting example an application may detect data from a game being played on the device. Upon processing this data the status drawer may be loaded with data from the media such as by means of a non-limiting example the media controller may detect the game “Angry Birds” being played on a device or another device connected to the device. Also it may be detected that the player is on Level 5. In some embodiments, controller 125 may issue a flag to signal the application to load the status drawer with the status data in step 610 for example, “Playing Angry Birds, Level 5”. In one or more embodiments, controller 125 may also initialize the status drawer and send a prompt to the user to open the drawer. In a non-limiting example, a controller 125 may signal a notification message to the user. In the present embodiment a user may select a status from the drawer in step 615 and define an availability status for the activity selected in a step 620. In the present embodiment, controller 125 may continuously and/or repeatedly determine whether media data conditions exist in a step 630. In some embodiments, an application and/or service may run while suitable media data conditions may exist. In the present embodiment, if controller 125 detects a disruption or termination, controller 125 may initialize a timing mechanism. In some embodiments, timing mechanism may be within the controller 125. In the present embodiment, controller 125 may determine whether a timing threshold may be exceeded. In a non-limiting example, a threshold limit may be 30 seconds. Further, in the present embodiment, if timing threshold is not exceeded, device 100 may continue to sample and/or process media data. In some embodiments, device 100 may sample and/or process media data if data is detected before timing threshold exceeded. In the present embodiment, if timing threshold is exceeded, controller 125 may signal an application and/or service to stop in a step 635 upon which the application returns to the detect media state in step 600. In another embodiment, upon detecting and processing the media the controller 125 may signal an application and/or service to load an avatar drawer with selections and/or data related to the media detected in a step 610. In a non-limiting example, a game in play or initialized may be detected on a device or another device connected to the media controller 125. Upon processing the media in step 605, the controller 125 may load familiar characters from the game detected to the avatar for quick selection in step 610. In a non-limiting example, the user playing the game may commence an avatar based video chat with one or more users on the network and choose an avatar related to the game in play from an avatar drawer which was loaded in 610. Relevant data may also be loaded and sent over the network along with the avatar based video chat session to other devices on the network which may serve as a method of advertising the game in play, such as but not limited to data about the game in play and or a dynamic link for users viewing the avatar over the network to purchase the game.

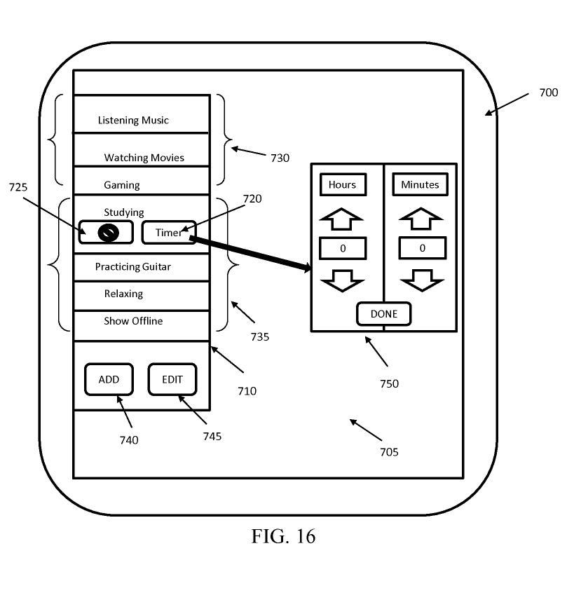

FIG. 16 is an illustration showing how the expiration 720 and availability identifier 725 may be implemented allowing the user to assign either to a status selection. The figure also shows an examples of status that may be auto loaded and flushed from a status drawer based on media detection in 730. The drawer maybe edited where users may add their own status 740 to the drawer and edit the message sent to the community when the status is selected as well as edit which users will receive the status 745.

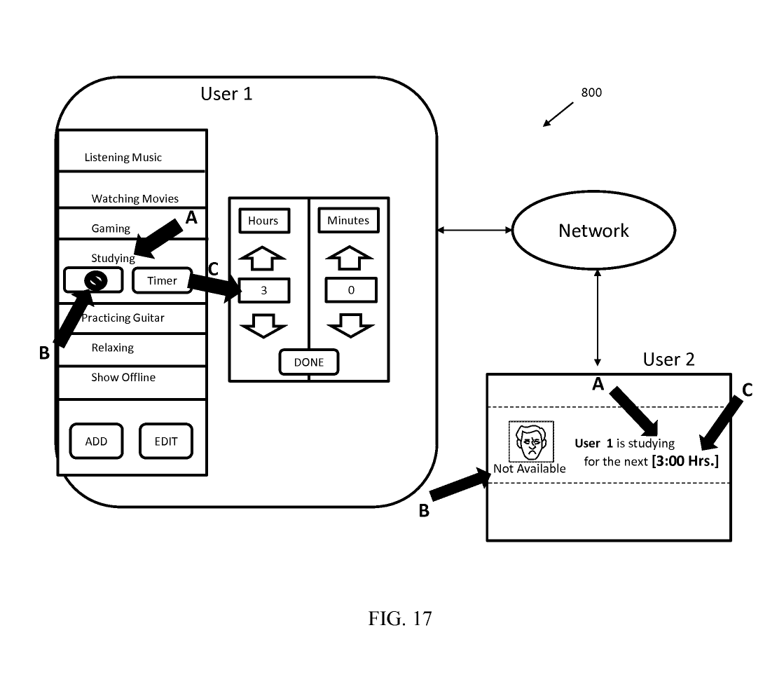

FIG. 17 illustrates an example of a selected status with added expiration and availability identifier and how it may appear on another user's device who is receiving the status information over a network.

In some embodiments, embodiment software may import data from external platforms. In a non-limiting example, software may import social media contacts from Facebook, Yahoo, etc. Some embodiments may allow users to add and/or invite other users. In a non-limiting example, users may add and/or invite imported contacts to become part of users' network. In some embodiments, software may be suitable for detecting various media data, including, without limitation, audio data, video data, textual data, data from a game, film, website etc. In some of these embodiments, software may be suitable for sampling and/or processing of detected data. In a non-limiting example, software may process media data to determine whether user may be performing certain actions such as, without limitation, playing video games, listening to music, watching videos, etc. In another non-limiting example software may process media data to determine information about the media such as name of the media and other pertinent information about the media. In a non-limiting example, software may initialize a status drawer from a messenger application in response to user activity detection. In another non-limiting example, software may preload the status drawer with data associated with the media detected. In yet another non-limiting example, the software may issue a prompt to the user to manually select a status from the status drawer. In some embodiments, software may perform continuous and/or repeated processing of media data. In one or more embodiment, software may stop all related status notifications upon detection that the media is no longer active, such as the user is no longer listening to a particular song, watching a particular movie or listening to music or watching videos in general.

In one embodiment, users may select user-defined or preloaded status from the status drawer, in some embodiments the user may be given the flexibility of quickly assigning an availability identifier to a status selected from the drawer. The availability identifier may be used to identify whether user is available or unavailable for the particular status selected. In another embodiment the user may be given the ability to add a timer expiration of the status selected from the drawer. The expiration is used to signal to the user's community how long the status will occur for. For example, [Ted is Mobile Gaming] for the next [45 minutes]. In some embodiments the timer is updated and displayed in real time to the user's community via a notification. In many embodiments the user may have the ability to change the status, availability identifier and timed expiration on a whim.

In one embodiment, if an availability identifier is selected that signals that the user is unavailable, then the software may block text messages from appearing on the device screen directly associated with the status. In one embodiment messages may be received over a network and arranged on a recipient's device or accessed on the device in manner such as appearing as though the messages are stacked one on top of another. In one embodiment the messages are accessed in a singular mode or one at a time, which may be in order to preserve the device screen space, be more efficient and offer less distraction on screen. In one embodiment the software application may operate in multitask mode allowing the user to send and receive messages while performing other activities in the background such as but not limited to gaming, watching movies or listening to music.

In some embodiments, media detection software may run in background of a device. In one or more embodiments, media detection software may provide high efficiency. In a non-limiting example, detection software may not run if device screen may be off and/or locked. In some embodiments, media detection software may employ a variety of mechanisms.

In some embodiments, an “application” may be any software program, including, without limitation, a chat application, Social Media Networking application, or other media application. In some of these embodiments, application may check user network status. In a non-limiting example, application may determine if members of user's network are online. In some embodiments, network information may be populated in device notification system, and user may check status as with other notifications. In at least one embodiment, user may check messages from others through notification service.

In a non-limiting example, software may initiate a text session with another user from a floating window and/or device notification dropdown function or from opening the application. Further, in the present non-limiting example, window may default to top left hand corner or other portion of device screen. Still further, in the present non-limiting example, user may be able to move window to a desired location. Further, in the present non-limiting example, user may be able to resize window. Still further, in the present embodiment, user may be able to identify sender of incoming text.

In other embodiments, an application may be able to run in a standalone mode, in which user may access any functionalities of an application in a device foreground. In some of these embodiments, software may be suitable to perform a variety of functions, including, without limitation: accessing application settings; sending standard texts (not using singular mode stacked messaging); recording, uploading, and/or sending photos; recording, uploading, and/or sending video text; performing live video chat; performing audio only chat; searching for users in a database; and inviting users from a database.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation:

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non- patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing processing of media data according to the present invention will be apparent to those skilled in the art. Various aspects of the invention have been described above by way of illustration, and the specific embodiments disclosed are not intended to limit the invention to the particular forms disclosed. The particular implementation of the processing of media data may vary depending upon the particular context or application. By way of example, and not limitation, the processing of media data described in the foregoing were principally directed to audio implementations; however, similar techniques may instead be applied to video, text, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of managing social media distractions over a social networking application by executing computer-executable instructions stored on a non-transitory computer-readable medium comprises the steps of:
(A) providing a plurality of user accounts on a networking application;
(B) providing a media application;
(C) detecting a media event, wherein the media event is facilitated by the media application;
(D) identifying media characteristics for the media event;
(E) generating a media-specific status description according to the media characteristics, if the media event is detected;
(F) storing the media-specific status description in a status repository; and
(G) displaying the media-specific status description with a specific account from the plurality of user accounts on the networking application.

2. A method of managing social media distractions over a social networking application by executing computer-executable instructions stored on a non-transitory computer-readable medium as claimed in claim 1 comprises the step of:
automatically sending login credentials for the specific account to the networking application in order to access the network application, if the media event is detected.

3. A method of managing social media distractions over a social networking application by executing computer-executable instructions stored on a non-transitory computer-readable medium as claimed in claim 1 comprises the step. of:
terminating the network application, if the media event ceases to be detected.

4. A method of managing social media distractions over a social networking application by executing computer-executable instructions stored on a non-transitory computer-readable medium as claimed in claim 1 comprises the steps of:
retrieving a media activity status from the media application in order to detect the media event; and
generating the media-specific status description, if the media activity status is active.

5. A method of managing social media distractions over a social networking application by executing computer-executable instructions stored on a non-transitory computer-readable medium as claimed in claim 1 comprises the steps of:
retrieving one or more audio samples through a system audio interface;
processing the audio samples with media detection software in order to detect the media event; and
identifying the media characteristics for the media event with the media identification software.

6. A method of managing social media distractions over a social networking application by executing computer-executable instructions stored on a non-transitory computer-readable medium as claimed in claim 1 comprises the steps of:
identifying the media event as a specific media;
identifying a media duration for the specific media; and
displaying the media-specific status description for the media duration.

7. A method of managing social media distractions over a social networking application by executing computer-executable instructions stored on a non-transitory computer-readable medium as claimed in claim 6 comprises the step of:
displaying the media duration with the media-specific status description on the networking application.

8. A method of managing social media distractions over a social networking application by executing computer-executable instructions stored on a non-transitory computer-readable medium as claimed in claim 1 comprises the steps of:
designating a time interval for the media-specific status description;
displaying the media-specific status description for the time interval; and
removing the media-specific status description when the time interval expires.

9. A method of managing social media distractions over a social networking application by executing computer-executable instructions stored on a non-transitory computer-readable medium as claimed in claim 1 comprises the steps of:
assigning an availability identifier for the media-specific status description; and
displaying the availability identifier with the media-specific status description.

10. A method of managing social media distractions over a social networking application by executing computer-executable instructions stored on a non-transitory computer-readable medium as claimed in claim 9 comprises the steps of:
designating the availability identifier as unavailable; and
disabling incoming messages for the specific account until a time interval expires for the media-specific status description expires.

11. A method of managing social media distractions over a social networking application by executing computer-executable instructions stored on a non-transitory computer-readable medium as claimed in claim 1 comprises the steps of:
retrieving at least one status description from the status repository, wherein the status repository is associated with the specific account;
displaying the status descriptions to the specific account;
receiving a status selection from the specific account, wherein the status selection corresponds to a specific status description from the plurality of status descriptions; and
displaying the specific status description with the specific account on the networking application.

12. A method of managing social media distractions over a social networking application by executing computer-executable instructions stored on a non-transitory computer-readable medium as claimed in claim 11 comprises the step of:
ceasing to display the status descriptions to the specific account, if the media event ceases to be detected.

13. A method of managing social media distractions over a social networking application by executing computer-executable instructions stored on a non-transitory computer-readable medium as claimed in claim 1 comprises the steps of:
providing at least one media-specific status description in the status repository; and
automatically displaying each of the media-specific status descriptions from the status repository to the specific account, if the media event is detected, wherein the specific account may select one of the media-specific status descriptions while the media event is active.

14. A method of managing social media distractions over a social networking application by executing computer-executable instructions stored on a non-transitory computer-readable medium as claimed in claim 1 comprises the steps of:
receiving a custom status description from the specific account;
receiving selections for an availability identifier and a time interval for the custom status description from the specific account; and
storing the custom status description in the status repository.

15. A method of managing social media distractions over a social networking application by executing computer-executable instructions stored on a non-transitory computer-readable medium as claimed in claim 14 comprises the step of:
associating a specific activity with the custom status description, wherein the specific activity is displayed with the custom status description.

16. A method of managing social media distractions over a social networking application by executing computer-executable instructions stored on a non-transitory computer-readable medium as claimed in claim 14 comprises the steps of:
retrieving the custom status description from the status repository; and
sending the custom status description over the networking application.

17. A method of managing social media distractions over a social networking application by executing computer-executable instructions stored on a non-transitory computer-readable medium as claimed in claim 1 comprises the steps of:
initializing a communication module of the network application, wherein the communication module facilitates video communication between the user account and at least one other account over a network;
transmitting audio data and video data from the at least one other account to the user account through the communication module;
processing the audio data in order to recognize media activity from the at least one other account;
displaying the video data to the user account, if the media activity is detected; and
ceasing to display the video data to the user account, if the media activity is no longer detected.

18. A method of managing social media distractions over a social networking application by executing computer-executable instructions stored on a non-transitory computer-readable medium as claimed in claim 1 comprises the steps of:
initializing a communication module of the network application, wherein the communication module facilitates video communication between the specific account and at least one other account;
continuously sampling for media data from the specific account wherein the media data comprises either audio data, video data, or both audio data and video data;
processing the media data in order to recognize speech activity;
transmitting the media data through the communication module to at least one other account from the plurality of user accounts, if the speech activity is recognized; and
ceasing to transmit the media data to each of the at least one other account, if the speech activity is no longer recognized.

19. A method of managing social media distractions over a social networking application by executing computer-executable instructions stored on a non-transitory computer-readable medium as claimed in claim 1 comprises the steps of:
providing that a plurality of messages are sent to the specific account from the plurality of user accounts through the networking application, wherein each of the messages is associated with a time stamp; and
displaying a visual representation of each of the messages to the specific account in a message stack, wherein the message stack is a virtual-spatial organization of the messages.

20. A method of managing social media distractions over a social networking application by executing computer-executable instructions stored on a non-transitory computer-readable medium as claimed in claim 19 comprises the steps of:
displaying the visual representation of a first message from the plurality of messages to the specific account atop the message stack, wherein the time stamp of the first message is more recent than the time stamps of older messages from the plurality of messages; and
displaying the visual representation of the older messages to the specific account behind the visual representation of the first message in the message stack, wherein the visual representation of the first message visually obscures the visual representation of the older messages.

21. A method of managing social media distractions over a social networking application by executing computer-executable instructions stored on a non-transitory computer-readable medium as claimed in claim 19 comprises the step of:
spatially organizing the message stack into an offset pattern.

22. A method of managing social media distractions over a social networking application by executing computer-executable instructions stored on a non-transitory computer-readable medium as claimed in claim 19 comprises the steps of:
receiving a command from the specific account to dismiss the first message; and
revealing the visual representation of a second message from the plurality of messages atop the message stack by removing the visual representation of the first message from the message stack.

23. A method of managing social media distractions over a social networking application by executing computer-executable instructions stored on a non-transitory computer-readable medium as claimed in claim 19 comprises the steps of:
providing a first series of messages and a second series of messages from the plurality of messages, wherein the first series of messages is sent from a first account from the plurality of user accounts and the second series of messages is sent from a second account from the plurality of user accounts, and wherein a timestamp of one of the messages from the first series of messages is more recent than the timestamp of any of the second series of messages; and
spatially organizing the first series of messages atop the second series of messages in the message stack.
